(19) United States
(12) Patent Application Publication
(10) Pub. No.: US 2024/0249175 A1
(43) Pub. Date: Jul. 25, 2024

(54) QUANTUM SYSTEM COMPRISING METASURFACES COMPRISING TRANSPARENT CONDUCTIVE MATERIAL

(71) Applicant: Quantinuum LLC, Broomfield, CO (US)

(72) Inventors: Adam Jay OLLANIK, Broomfield, CO (US); Matthew BOHN, Broomfield, CO (US)

(21) Appl. No.: 18/454,523

(22) Filed: Aug. 23, 2023

Related U.S. Application Data
(60) Provisional application No. 63/374,781, filed on Sep. 7, 2022.

(51) Int. Cl. G06N 10/40; G02B 1/00

(52) U.S. Cl. CPC G06N 10/40; G02B 1/002

(57) ABSTRACT

In various embodiments, a quantum object confinement apparatus comprising a plurality of electrodes and configured to define a confinement volume within configured for confining one or more quantum objects therein is provided. The confinement volume defines one or more quantum objects positions. The quantum object confinement apparatus comprises one or more metasurfaces that are configured to be associated with respective quantum object positions. The plurality of metasurfaces comprises of a plurality of transparent conducting oxide metamaterial structures.

### CROSS-REFERENCE TO RELATED APPLICATIONS

This application claims priority to and the benefit of U.S. Nonprovisional Application No. 63/374,781, filed on Sep. 7, 2022, the contents of the application is hereby incorporated by reference in its entireties.

### BACKGROUND

Ion traps use electrical and/or magnetic fields to capture one or more ions in a potential well. The ions and/or quantum states of the ions confined by the potential well may be manipulated using laser beams and/or the like. However, delivering these laser beams to the ion locations in a large scale ion trap is a significant challenge due to the low ion height above the trap, the Rayleigh range of the laser beams, and the amount of laser power that needs to be delivered to an ion within the trap to perform the desired manipulations. Through applied effort, ingenuity, and innovation many deficiencies of such prior laser beam delivery systems have been solved by developing solutions that are structed in accordance with the embodiments of the present invention, many example of which are described herein.

### BRIEF SUMMARY OF EXAMPLE EMBODIMENTS

Example embodiments provide confinement apparatuses, quantum computers comprising confinement apparatuses comprising metasurfaces formed, at least in part, from transparent conductive material, transparent conductive materials, transparent electrode, and/or the like where the transparent electrode is configured to have reduced electrostatic buildup on the metasurface.

Example embodiments provide methods, systems, apparatuses, computer program products and/or the like for providing one or more manipulation signals to a quantum object confined within a quantum object confinement apparatus and/or to capture and/or detect (optical) signals emitted by the quantum object. In various embodiments, the quantum objects are atoms, ions, pairs or groups of atoms and/or ions (e.g., ion crystals), molecules, quantum particles, and/or the like. For example, in various embodiments, the quantum objects are used as qubits of a quantum computer. In various such embodiments, the manipulation signals are configured to control photoionization, state preparation, qubit detection and/or reading, cooling, shelving, repumping, single qubit gates, and two qubit gates of the quantum computer. While example embodiments are described herein with respect to quantum computing applications (e.g., quantum charge coupled device (QCCD)-based quantum computers), various embodiments relate to atomic clocks and various other applications of quantum objects confined by respective quantum object confinement apparatuses, lithographically-defined arrays of quantum dots, and/or other applications requiring precise delivery of optical signals to particular locations and/or capturing of signals emitted at particular locations.

In various embodiments, the quantum object confinement apparatus has one or more metamaterial structures disposed/formed thereon and/or coupled/secured with respect thereto. In various embodiments, at least some of the metamaterial structures are configured such that a manipulation signal being incident on the metamaterial structures induces the metamaterial structures to emit a respective action signal onto a corresponding quantum object position and/or portion thereof. In various embodiments, at least some of the metamaterial structures are configured such that an emitted signal emitted by a quantum object at a corresponding quantum object position, induces the metamaterial structures to emit a collection signal toward collection optics configured to capture, detect, measure, and/or the like the collection signal.

According to an aspect of the present disclosure, a system is provided. In an example embodiment, the system comprises a quantum object confinement apparatus comprising a plurality of electrodes configured to generate a confinement potential configured to confine one or more quantum objects, the confinement potential defining a plurality of quantum objects positions; and one or more signal manipulation elements. Each signal manipulation element of the one or more signal manipulation elements (a) is associated with a respective quantum object position of the plurality of quantum object positions and (b) is configured to at least one of (i) responsive to an emitted signal emitted by an quantum object located at the respective quantum object position being incident on the collection array, provided an induced collection signal to a respective collection position or (ii) responsive to an incoming signal generated by a manipulation source being incident on the action array provide an induced action signal to the respective quantum object position. Wherein at least one of the signal manipulation elements comprises a metasurface comprising a plurality of structures formed at least in part of a transparent conductive material.

In an example embodiment, the plurality of quantum object positions are disposed in a two-dimensional layout.

In an example embodiment, each of the one or more signal manipulation elements comprises a metamaterial array.

In an example embodiment, the one or more signal manipulation elements comprises at least one of (a) a metamaterial array or (b) a diffractive optical element (DOE).

In an example embodiment, the quantum object confinement apparatus is a surface ion trap.

In an example embodiment, the action array is configured for use in performing a quantum computer function selected from a group consisting of photoionization of an quantum object, state preparation of the quantum object, reading a quantum state of the quantum object, cooling the quantum object or an quantum object crystal comprising the quantum object, shelving the quantum object, repumping the quantum object, performing a single qubit gate on the quantum object, and performing a multiple qubit gate on a set of quantum objects comprising the quantum object.

In the example embodiment, the one or more metamaterial structures of the plurality of metamaterial structures are pillars extending from a surface of the quantum object confinement device a distance in a range of 0.5 nm to lum.

In one or more embodiments, the dielectric material may comprise a transparent conducting oxide, such as indium tin oxide (ITO), for example. The metasurface may be formed, at least in part from one or more transparent conductive materials and serve as an optical device and/or an electrical contact. In one or more embodiments, one or more transparent conducting material may be used as transparent electrodes for photoactive devices.

In various embodiments, one or more transparent conducting material may be used as an optical device and/or as an electrode. The tunable electrical properties of the transparent conducting materials allow for adjustment using free carrier concentration.

In an example embodiment, the one or more structures of the metasurface comprise one or more solid pillars of a transparent conducting material (e.g., ITO).

In an example embodiment, the one or more structures of the metasurface comprise a dielectric core (e.g., Titanium dioxide) surrounded by a shell of transparent conducting material.

In an example embodiment, one or more photonic crystal(s) may be made of a solid transparent conducting material (e.g., ITO).

In an example embodiment, one or more photonic crystal(s) comprise a dielectric core (e.g., Titanium dioxide) surrounded by a shell of transparent conducting material.

### BRIEF DESCRIPTION OF THE FIGURES

Having thus described the invention on general terms, reference will now be made to the accompanying drawings, which are not necessarily drawn to scale, and wherein:

FIG. 1 is a schematic diagram illustrating an example quantum computing system comprising a quantum object confinement apparatus comprising metamaterial structures on a surface thereof, according to an example embodiment.

FIG. 2 is a schematic diagram of a portion of a surface of a quantum object confinement apparatus, according to an example embodiment in accordance with the present disclosure.

FIG. 3 is a schematic diagram of a zoomed in portion of the surface of the quantum object confinement apparatus shown in FIG. 2, according to an example embodiment in accordance with the present disclosure.

FIG. 4A is a partial cross-sectional view of a quantum object confinement apparatus comprising an action array formed of an array metamaterial structures on a surface thereof, according to an example embodiment in accordance with the present disclosure.

FIG. 4B is a partial cross-sectional view of a quantum object confinement apparatus comprising a collection array formed of an array of metamaterial structures on a surface thereof, according to an example embodiment in accordance with the present disclosure.

FIG. 4C is a partial perspective view of an array of metamaterial structures, according to an example embodiment in accordance with the present disclosure.

FIG. 5 provides a schematic diagram of a portion of a confinement apparatus, in accordance with an example embodiment in accordance with the present disclosure.

FIG. 6A is a cross-sectional view of an exemplary metamaterial structure comprising of a solid transparent conducting material in accordance with the present disclosure.

FIG. 6B is a cross-sectional view of an exemplary metamaterial structure comprising of a core of an oxide material and a shell made of transparent conducting material in accordance with the present disclosure.

FIG. 7 is a schematic diagram of a portion of a surface of a quantum object confinement apparatus comprising another arrangement of meta-material arrays on a surface thereof, according to an example embodiment in accordance with the present disclosure.

FIG. 8 provides a schematic diagram of an example controller of a quantum computer configured to perform one or more deterministic reshaping and/or reordering functions, according to various embodiments in accordance with the present disclosure.

FIG. 9 provides a schematic diagram of an example computing entity of a quantum computer system that may be used in accordance with an example embodiment in accordance with the present disclosure.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

The singular form of “a,” “an,” and “the” include plural references unless otherwise stated. The terms “includes” and/or “including,” when used in the specification, specify the presence of stated features, elements, and/or components, and/or groups thereof. As used herein, the phrase “in an embodiment,” “according to one embodiment,” and the like generally mean that the particular feature, structure, or characteristic following the phrase may be included in at least one embodiment of the present disclosure and may be included in more than one embodiment of the present disclosure. The term “transparent” when used in the specification, means transparent to a certain wavelength of interest.

In various embodiments, methods, apparatuses, systems, computer program products, and/or the like for providing manipulation signals to quantum object positions within a quantum object confinement apparatus and/or collecting, capturing, detecting, and/or measuring emitted signals emitted by quantum objects confined by the quantum object confinement apparatus. For example, various embodiments provide a signal management system associated with and/or comprising the quantum object confinement apparatus and comprising one or more signal manipulation elements. In various embodiments, one or more signal manipulation elements are used to provide the manipulation signals to quantum object positions defined by the quantum object confinement apparatus and/or collect, capture, detect, and/or measure emitted signals emitted by quantum objects located at quantum object positions.

In various embodiments, the quantum object is an atom and/or ion, neutral or ionic molecule, quantum particle, quantum dot, and/or other objects whose respective quantum state is controllable via application of manipulation signals. The quantum object may be qubit quantum object of a quantum object crystal comprising two or more quantum objects, with, in an example embodiment, the two or more quantum objects of the quantum object crystal comprising quantum objects of at least two different atomic numbers. In an example embodiment, the quantum object confinement apparatus is an ion trap (e.g., a surface ion trap, Paul trap, and/or the like).

In various embodiments, the one or more signal manipulation elements are disposed and/or mounted with respect to the quantum object confinement apparatus such that the signal manipulation elements form at least a portion of respective optical paths between respective quantum object positions and respective manipulation sources and/or photodetectors.

In various embodiments, at least one of the signal manipulation elements of the signal management system is disposed on a surface of the quantum object confinement apparatus and/or at least partially within a first substate on which the quantum object confinement apparatus is formed. For example, the quantum object confinement apparatus is formed on a first substrate, in various embodiments, with the at least one signal manipulation element formed and/or disposed on a surface of the first substrate. As should be understood, the first substrate may comprise multiple layers of circuitry configured to control various elements/components of the operation of the functioning of the quantum object confinement apparatus. In an example embodiment, at least one of the signal manipulation elements is part of the quantum object confinement apparatus and set back and/or recessed with respect to the surface of the quantum object confinement apparatus. For example, the at least one signal manipulation element may be located at a fabricated layer that is within the first substrate and/or not directly on the surface defined by the plane of the quantum object confinement apparatus. For example, there may be a hole or opening in the surface of the quantum object confinement apparatus with the at least one signal manipulation element recessed therein. In an example embodiment, a transparent layer encloses the at least one signal manipulation element within the hole or opening. Various embodiments provide a quantum object confinement apparatus having one or more signal manipulation elements formed and/or disposed on the surface of the quantum object confinement apparatus and/or as part of the substrate comprising the quantum object confinement apparatus.

An example embodiment provides a second substrate having one or more signal manipulation elements formed and/or disposed thereon and/or therein that is mounted in a secured relationship with respect to the quantum object confinement apparatus such that manipulation signals can be provided to the quantum object positions via respective signal manipulation elements of the second substrate.

In various embodiments, each signal manipulation element is formed and/or configured for use in performing one or more functions (photoionization, state preparation, qubit detection and/or reading, cooling, shelving, repumping, single qubit gates, or two qubit gates) of a QCCD-based quantum computer. For example, in various embodiments, a signal management element is a metamaterial array comprising a plurality of metamaterial structures. In various embodiments, each of the plurality of metamaterial structures are positive metamaterial structures (e.g., pillars, columns, cylinders, and/or the like). In various embodiments, each of the plurality of metamaterial structures are negative metamaterial structures (e.g., holes, pits, pockets, bubbles, and/or the like). In various embodiments, a metamaterial array may comprise a combination of positive and negative metamaterial structures. In various embodiments, some of the metamaterial arrays consist of and/or comprise positive metamaterial structures and other metamaterial arrays consist of and/or comprise negative metamaterial structures.

In various embodiments, each signal manipulation element is configured to provide a resonant response for incident signals (e.g., incoming manipulation signals and/or emitted signals) of a respective particular wavelength range. In various embodiments, a signal manipulation element is a metasurface comprising one or more metamaterial structures formed of a transparent conducting material that is transparent for wavelengths in the respective particular wavelength range. For example, for an incident signal (and/or portion thereof) characterized by a wavelength within the respective particular wavelength range, the signal manipulation element will be induced to emit a controlled induced signal (e.g., controlled in terms of direction, focus, beam profile, polarization, and/or the like) as a result of the incident signal being incident on the signal manipulation element. However, if the incident signal (and/or portions of the incident signal) there are characterized by one or more wavelengths outside of the respective particular wavelength range, the resulting signal would have a uniform phase delay applied thereto but would not experience the focusing, polarization control, beam profile control, and/or the like of the controlled induced signal. In other words, the signal manipulation elements may be used as chromatic filters, in various embodiments. For example, one or more signals of various wavelengths and/or signal comprising various wavelengths may be made incident on a signal manipulation element. The chromatic filtering performed by the signal manipulation element (e.g., a metamaterial array configured to have a resonant response for a respective particular wavelength) causes the controlled induced signal to only include a respective particular wavelength and/or wavelengths of the respective particular wavelength range the signal manipulation element is configured for use with. For example, an incoming manipulation signal incident on a signal manipulation element will only be focused onto the corresponding quantum object position when the incoming manipulation signal is characterized by a wavelength within the respective particular wavelength range.

In various embodiments, a signal manipulation element is configured to have more than one manipulation signals incident thereon and be induced to emit respective action signals responsive thereto. For example, a signal manipulation element may be configured to, responsive to a first manipulation signal of a first wavelength and first polarization being incident thereon, be induced to emit a first action signal having a wavelength corresponding to the first wavelength, a polarization corresponding to the first polarization, and being directed toward a first portion of the corresponding quantum object position. The same signal manipulation element is configured to, responsive to a second manipulation signal of a second wavelength and a second polarization being incident thereon, be induced to emit a second action signal having a wavelength corresponding to the second wavelength, a polarization corresponding to the second polarization, and being directed to a second portion of the corresponding quantum object position, in an example embodiment. In various embodiments, the first wavelength and second wavelength are substantially the same and the first polarization and second polarization are different. In an example embodiment, the first wavelength and the second wavelength are different, and the first polarization and the second polarization are substantially the same. In an example embodiment, the first wavelength and the second wavelength are different, and the first polarization and the second polarization are different. The first portion of quantum object position and the second portion of the quantum object position may or may not overlap, as appropriate for the application. In various embodiments, the first manipulation signal and the second manipulation signal may be provided at least partially simultaneously. For example, the first manipulation signal and the second manipulation signal may be incident on the signal manipulation element at the same time for at least a part of the time that the first manipulation signal and/or the second manipulation signal are incident on the signal manipulation element. In an example embodiment, the first manipulation signal and the second manipulation signals are provided separately (e.g., not overlapping in time).

In various embodiments, a signal manipulation element is configured to be induced to emit an action signal and/or collection signal responsive to an incoming manipulation signal and/or emitted signal within a corresponding wavelength range being incident thereon. For example, each function of the quantum computer may be associated with one or more wavelengths. A respective signal manipulation element may therefore correspond to one or more functions of the quantum computer, where the one or more functions of the quantum computer correspond to wavelengths within the wavelength range at which the plurality of metamaterial structures of the respective signal manipulation element are configured to operate.

In various embodiments, with each signal manipulation element is associated with a corresponding quantum object position defined by the quantum object confinement apparatus. In various embodiments, one or more quantum object positions defined by the quantum object confinement apparatus are associated with an arrangement of signal manipulation elements comprising a plurality of signal manipulation elements. In various embodiments, each signal manipulation element an arrangement of signal manipulation elements associated with a quantum object confinement apparatus is configured to for use in performing one or more functions of the quantum computer (e.g., photoionization, state preparation, qubit detection and/or reading, cooling, shelving, repumping, single qubit gates, two qubit gates, emitted signal detection, and/or the like). For example, performance of various functions of the quantum computer may include use of manipulation signals and/or detection of emitted signals of various wavelengths. Various signal manipulation elements are configured for use at different wavelengths such that a particular signal manipulation element of an arrangement of signal manipulation elements is configured for use when performing one or more corresponding functions of the quantum computer at the associated quantum object position.

In various embodiments, a signal manipulation element is configured to be induced to emit an action signal and/or collection signal responsive to an incoming manipulation signal and/or emitted signal within a corresponding wavelength range being incident thereon. For example, each function of the quantum computer may be associated with one or more wavelengths. A respective signal manipulation element may therefore correspond to one or more functions of the quantum computer, where the one or more functions of the quantum computer correspond to wavelengths within the wavelength range at which the plurality of metamaterial structures of the respective signal manipulation element are configured to operate.

Conventionally, metasurfaces are formed of dielectric materials. However, placing dielectric materials on the surface of the quantum object confinement apparatuses can lead to the buildup of electrostatic charge on and/or near the quantum object confinement apparatus. As the size of the quantum object confinement apparatus (and the number of metasurfaces thereon) increases, the possibility of buildup of electrostatic charge on and/or near the quantum object confinement apparatuses also increases. Thus, a technical problem exists as to how to provide manipulation signals to a quantum object confinement apparatus using metasurfaces that is able to scale with the size and/or dimensions of the quantum object confinement apparatuses while reducing the possibly of electrostatic charge buildup on the quantum object confinement apparatus.

Various embodiments provide technical solutions to these technical problems. In particular, in various embodiments, the metasurfaces comprise transparent conducting materials. For example, the metasurfaces comprise transparent conducting oxides (e.g., ITO, and/or the like), in various embodiments. In various embodiments, the metasurfaces comprise a surface (e.g., formed by the exterior surfaces of the plurality of structures that make up the metasurface) that is made of a conducting transparent material such that the surface can be grounded to prevent buildup of static electric charge thereon. Thus, various embodiments provide technical solutions to technical problems regarding how to provide manipulation signals to a quantum object confinement apparatus such that the electrostatic buildup on and/or near the metasurfaces are reduced.

### Example Quantum Computing System Comprising a Quantum Confinement Apparatus

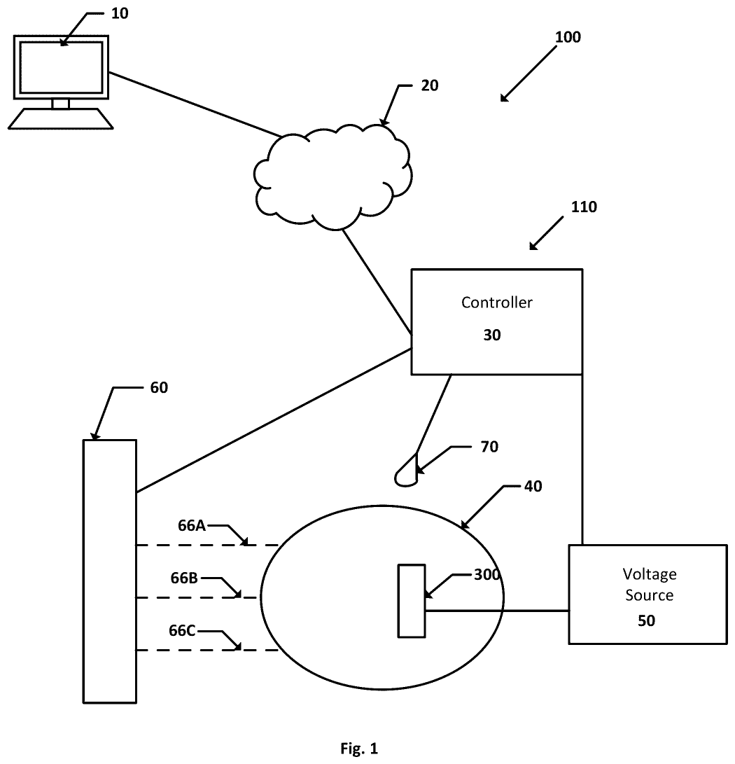

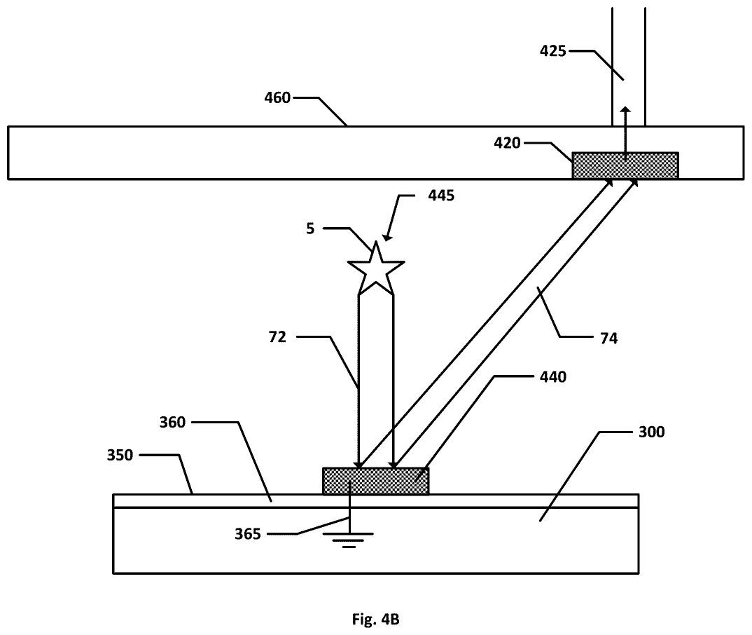

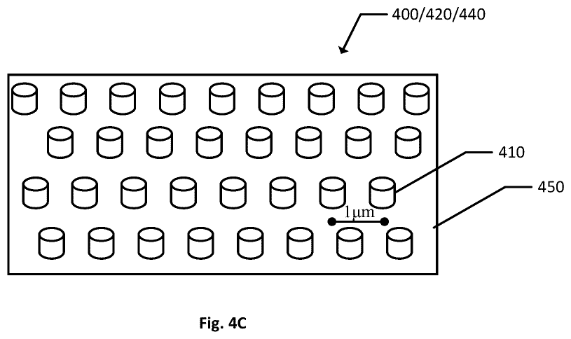

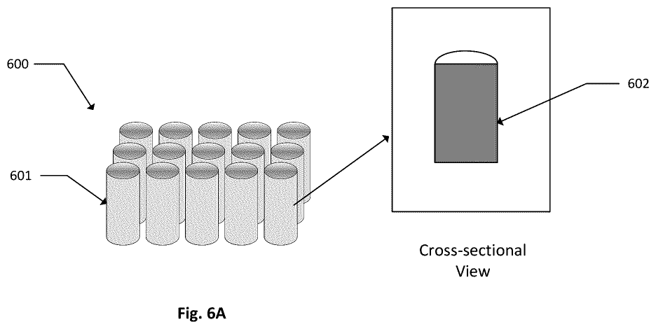

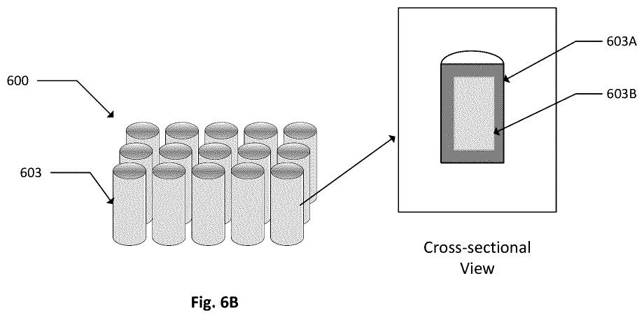

FIG. 1 provides a schematic diagram of an example quantum computing system 100 comprising a quantum object confinement apparatus 300 (e.g., an ion trap and/or the like), in accordance with an example embodiment. As shown in FIGS. 4A, 4B, and 6, in various embodiments, a plurality of signal manipulation elements is formed and/or disposed on a surface of the quantum object confinement apparatus. In various embodiment, at least a portion of the signal manipulation elements formed and/or disposed on the surface of the quantum object confinement apparatus are configured to be induced to emit an action signal toward and/or focused onto a respective quantum object position responsive to an incoming signal being incident thereon. The incoming signal is at least portion of a manipulation signal generated by a manipulation source 60 of the quantum computer 110. In various embodiments, at least one signal manipulation element formed and/or disposed on the surface of the quantum object confinement apparatus is configured to be induced to emit a collection signal toward and/or focused onto a collection position (e.g., where corresponding collection optical elements are disposed) corresponding to the respective quantum object position responsive to an emitted signal emitted by a quantum object located at the respective quantum object position.

In various embodiments, the quantum computing system 100 comprising a computing entity 10 and a quantum computer 110. In various embodiments, the quantum computer 110 comprises a controller 30, a cryostat and/or vacuum chamber 40 enclosing a confinement apparatus 300 (e.g., an ion trap), and one or more manipulation sources 60. For example, the cryostat and/or vacuum chamber 40 may be pressure-controlled chamber. In an example embodiment, the manipulation signal generated by the manipulation sources 60 are provided to the interior of the cryostat and/or vacuum chamber 40 (where the quantum object confinement apparatus 300 is located) via corresponding optical paths 66 (e.g., 66A, 66B, 66C). In various embodiments, the optical paths 66 are defined at least in part by one or more components and/or elements of the signal management system. For example, at least one of the optical paths 66 comprise and/or is in part defined by a signal manipulation element of the signal management system.

In an example embodiment, the one or more manipulation sources 60 may comprise one or more lasers (optical lasers, microwave sources, and/or the like). In various embodiments, each manipulation source 60 is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more quantum objects within the confinement apparatus. For example, in an example embodiment, wherein the one or more manipulation sources 60 comprise one or more lasers, the lasers may provide one or more laser beams to quantum objects trapped by the confinement apparatus 300 within the cryostat and/or vacuum chamber 40.

For example, a manipulation source 60 generates a manipulation signal that is provided as an incoming signal to an appropriate signal manipulation element of the signal management system. The incoming signal being incident on the signal manipulation element, for example a metamaterial array, induces the plurality of metamaterial structures of the metamaterial array to emit an action signal directed toward and/or focused on a corresponding quantum object position of the quantum object confinement apparatus. For example, the manipulation sources 60 may be configured to generate one or more beams that may be used to initialize a quantum object into a state of a qubit space such that the quantum object may be used as a qubit of the confined quantum object quantum computer, perform one or more gates on one or more qubits of the confined quantum object quantum computer, read and/or determine a state of one or more qubits of the confined quantum object quantum computer, and/or the like.

In various embodiments, the quantum computer 110 comprises an optics collection system 70 configured to collect and/or detect photons generated by qubits (e.g., during reading procedures). The optics collection system 70 may comprise of one or more optical elements (e.g., lenses, mirrors, waveguides, fiber optic cables, and/or the like) and one or more photodetectors. In various embodiments, the photodetectors may be photodiodes, photomultipliers, charge-couple device (CCD) sensors, complementary metal oxide semiconductor (CMOS) sensors, Micro-Electro-Mechanical Systems (MEMS) sensor, and/or other photodetectors that are sensitive to light at an expected fluorescence wavelength of the qubits of the quantum computer. In various embodiments, the detectors may be in electronic communication with the controller 30 via one or more A/D converts (FIG. 1) and/or the like. For example, a quantum object being read and/or having its quantum state determined may emit an emitted signal, at least a portion of which is incident on a collection array of the signal management system. The emitted signal being incident on the collection array induces the plurality of metamaterial structures of the collection array to emit a detecting signal directed toward and/or focused at collection optics of the quantum object confinement apparatus. The collection optics are configured to provide the collection signal to a photodetector.

In various embodiments, the quantum computer 110 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 300, in an example embodiment.

In various embodiment, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources 50, cryostat system and/or vacuum system controlling the temperature and pressure within the cryostat and/or vacuum chamber 40, manipulation sources 60, optics collection system 70, and/or other systems controlling various environmental conditions (e.g., temperature, pressure, and/or the like) within the cryostat and/or vacuum chamber 40 and/or configured to manipulate and/or cause a controlled evolution of quantum states of one or more quantum objects within the confinement apparatus. For example, the controller 30 may cause a controlled evolution of quantum states of one or more quantum objects within the confinement apparatus to execute a quantum circuit and/or algorithm. For example, the controller 30 may cause a reading procedure comprising coherent shelving to be performed, possibly as part of executing a quantum circuit and/or algorithm. In various embodiments, the quantum objects confined within the confinement apparatus are used as qubits of the quantum computer 110.

### Example Quantum Object Confinement Apparatus

In various embodiments, the atomic confinement apparatus comprises a plurality of electrodes that are configured to generate a confining potential. For example, the controller 30 may control the voltage source 50 to provide electrical signals to the electrodes of the quantum object confinement apparatus such that the electrodes generate a confining potential. The confining potential is configured to confine a plurality of quantum objects within a confinement volume defined by the quantum object confinement apparatus. For example, in an example embodiment, the quantum object confinement apparatus is a surface ion trap, and the confinement volume is a volume located proximate the surface of the surface ion trap. In various embodiments, the electrodes and/or confining potential are configured to define a plurality of quantum object positions within the confinement volume.

In various embodiments, the quantum object positions are disposed in a one-dimensional or two-dimensional lay out. For example, in an example embodiment, the quantum object positions are disposed along an axis of a linear quantum object confinement apparatus. In another example embodiment, the quantum object positions are disposed in a two-dimensional array or layout defined by a two-dimensional quantum object confinement apparatus. An example linear quantum object confinement apparatus is described by U.S. application Ser. No. 16/717,602, filed Dec. 17, 2019, though various other linear quantum object confinement apparatuses may be used in various embodiments. An example two-dimensional quantum object confinement apparatus is described by U.S. Application No. 63/199,279, filed Dec. 17, 2020, though various other two-dimensional quantum object confinement apparatuses may be used in various embodiments.

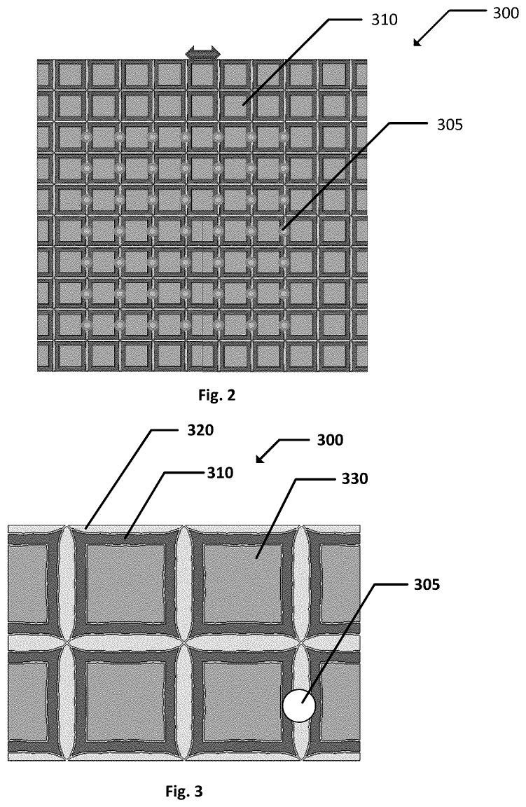

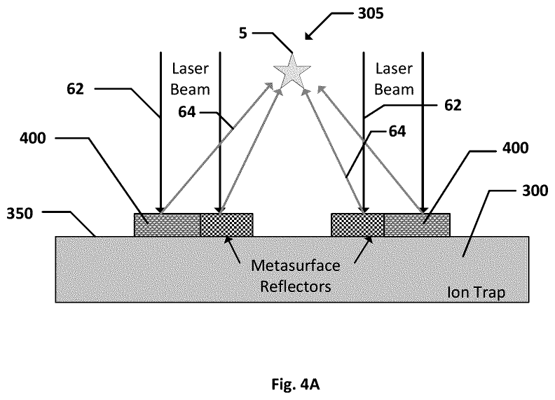

In various embodiments, the confining potential evolves with time, based on the electrical signals provided to the electrodes by the voltage sources 50. The evolving of the confining potential may be configured to cause one or more quantum objects to move from respective first quantum object positions to respective second quantum object positions. FIGS. 2 and 3 each illustrate portions of an example two-dimensional quantum object confinement apparatus 300 comprising sequences of electrodes 310 that are separated by a spacing factor α. In an example embodiment, the spacing factor α is in a range between 500 μm and 1000 μm (e.g., approximately 750 μm). The sequences of electrodes 310 define a plurality of quantum object positions 305. In various embodiments, a quantum object position 305 is a volume corresponding to a portion of an quantum object path 320 where the electrodes 310 are configured to maintain an quantum object (e.g., as part of an quantum object crystal) and/or a pair or set of quantum objects (e.g., for performing two or more qubit gates) for the performance of a function of the quantum computer and/or to store one or more quantum objects during the performance of functions of the quantum computer on other quantum objects located at other atomic positions.

In the illustrated embodiment, the sequences of electrodes 310 define a plurality of islands 330 and quantum object paths 320. In various embodiment, the quantum objects may travel between various quantum object positions 305 along quantum object paths 320. In general, the quantum objects are not located over the islands 330. In various embodiments, one or more signal manipulation elements (e.g., action arrays) may be disposed and/or formed on islands 330. In various embodiments, one or more signal manipulation elements (e.g., collection arrays) may be disposed and/or formed on the quantum object paths 320.

In various embodiments, the voltage sources 50 provide electrical signals to the potential generating elements (e.g., electrodes 310) of the confinement apparatus 300, such that a confining potential id formed. Based on the contours and time evolution of the confining potential one or more quantum objects are confined at respective quantum object positions, moved between quantum object positions and/or the like. When a quantum object is located at a quantum object position, one or more functions (e.g., quantum computing functions) may be performed on the quantum object. An example function that may be performed on a quantum object is photoionization of the quantum object. For example, a manipulation signal may be applied to quantum object to photo ionize the quantum object.

Another example function that may be performed on a quantum object is state preparation of the quantum object. For example, one or more manipulation signals may be applied to the quantum object to prepare the quantum object in a particular quantum state. For example, the particular quantum state may be a state within a defined qubit space used by the quantum computer such that the quantum object may be used as a qubit of the quantum computer.

Another example function that may be performed on a quantum object is reading a quantum state of the quantum object. For example, a manipulation signal (e.g., a reading signal) may be applied to the quantum object. When the quantum object's wave function collapses into a first state of the qubit space, the quantum object will fluoresce in response to the reading signal being applied thereto. When the quantum object's wave function collapses into a second state of the qubit space, the quantum object will not fluoresce in response to the reading signal being applied thereto.

Another example function that may be performed on a quantum object is cooling the quantum object or a quantum object crystal comprising the quantum object. A quantum object crystal is a pair or set of quantum objects where one of the quantum objects of the quantum object crystal is qubit quantum object used as a qubit of the quantum computer and the one or more other quantum objects of the quantum object crystal are used to perform sympathetic cooling of the qubit quantum object. For example, a manipulation signal (e.g., a cooling signal or a sympathetic cooling signal) may be applied to the quantum object or quantum object crystal to cause the (qubit) quantum object to be cooled (e.g., reduce the vibrational and/or other kinetic energy of the (qubit) quantum object).

Another example function that may be performed on a quantum object is shelving the quantum object. In various embodiments, quantum objects in the second state of the qubit space may be shelved during the performance of a reading function. For example, a shelving operation may comprise causing the quantum state of a quantum object in the second state of the qubit space to evolve to an at least meta-stable state outside of the qubit space while a reading operation is performed. An example shelving process is describe by U.S. Application No. 63/200,263, filed Feb. 25, 2021, though various other shelving processes may be used in various embodiments. In various embodiment, the shelving of a quantum object is performed by applying one or more manipulation signals to the quantum object to cause the quantum object's quantum state to evolve to an at least meta-stable state outside of the qubit space when the quantum object is in the second state of the qubit space.

Another example function that may be performed on a quantum object is (optical) repumping of the quantum object. In various embodiments, repumping of the quantum object comprises applying one or more manipulation signals to the quantum object to cause the quantum state of the quantum object to evolve to an excited state.

Another example function that may be performed on a quantum object is performing a single qubit gate on the quantum object. For example, one or more manipulation signals may be applied to the quantum object to perform a single qubit quantum gate on the quantum object.

Another example function that may be performed on a quantum object is performing a two-qubit gate on the quantum object. For example, one or more manipulation signals may be applied to a pair or set of quantum objects that includes the quantum object to perform a two qubit (or three, four, or more) quantum gate on the quantum object and the at least one other quantum object.

In various embodiments, the quantum object positions may be disposed in a one-dimensional lay out. For example, in an example embodiment, the quantum object positions are disposed along an axis of a linear quantum object confinement apparatus. In one or more embodiment, the quantum object positions may be disposed in a two-dimensional lay out. In another example, the quantum object positions are disposed in a two-dimensional array or layout that may be defined by a linear axis and a vertical axis of a quantum object confinement apparatus.

In various embodiments, the quantum object confinement apparatus 300 comprises one or more signal manipulation elements. In various embodiments, one or more of the signal manipulations elements are metamaterial arrays and each metamaterial array comprises a plurality of metamaterial structures which each define and/or comprise a respective metamaterial surface. The array of metamaterial structures (e.g., the composite surface formed by combining the respective metamaterial surfaces of the plurality of metamaterial structures) forms and/or provide a photonic metasurface. The terms metamaterial array and photonic metasurface are used interchangeably herein.

A photonic metasurface is an engineered surface designed to manipulate light through coherent interference implemented through local control of the amplitudes, phase, and/or polarization of reflected or transmitted light. This control is implemented by an array of optical scattering elements (e.g., the metamaterial structures), each of which have dimensions on the scale of the wavelength of light or smaller in at least one dimension, with spacing on the scale of the wavelength of light or smaller. For example, a photonic metasurface, as used herein, refers to composite metasurface formed by the plurality of metamaterial structures of a metamaterial array. The metamaterial structures of a metamaterial array are approximately wavelength or sub-wavelength (e.g., nanometer scale), high contrast structures (compared to other portions of the surface of the quantum object confinement apparatus 300) whose geometry, size, arrangement, and orientation control the phase, amplitude, and polarization of electromagnetic waves. This control of the electromagnetic waves is not a result of the bulk material used to make the metamaterial structure, but rather a result of the size and shape of the metamaterial structures.

In various embodiments, the metamaterial structures may be columns, pillars, and/or the like. For example, in various embodiments, each metamaterial structure may comprise of a solid metamaterial structure. For example, in an example embodiment, one or more metamaterial structures may comprise of a solid core of transparent conductive oxide, such as ITO, for example. In various embodiments, one or more metamaterial structures may comprise of a core made of dielectric and/or non-conductive oxide material (e.g., titanium dioxide) with a shell comprising transparent conductive oxide (e.g., ITO) at least partially covering and/or surrounding the core.

In one or more embodiments, the metamaterial structures (pillars, columns, etc.) may be used as photonic crystals. In some embodiments, photonic crystals are periodic dielectric structures that may be designated to form an energy band structure for photons. In one or more embodiments, one or more photonic crystals allows for propagation of electromagnetic waves. In one or more embodiments, the metamaterial structures (pillars, columns, etc.) may be used as diffractive optical elements (DOEs, e.g., lenses, gratings, and/or the like). In some embodiments, diffractive optical elements that may operate by interfering with and/or diffracting with one or more incident signals to produce a desired induced signal.

In various embodiments, one or more photonic metasurface that are configured to modify the geometric phase using one or more electric or magnetic resonances are used. In various embodiments, photonic metasurfaces may be configured to modify propagation phase without resonance (e.g., truncated waveguides) are used. In various embodiments, the photonic metasurfaces are dielectric (e.g., the arrays of metamaterial structures that forms the photonic metasurfaces comprise dielectric cores) and/or plasmonic metasurfaces using two or more electric or magnetic resonance of any order to locally engineer the desired phase and amplitude response of the respective photonic metasurface. Various other types of metamaterial structures that define various types of metamaterial surfaces are used in various embodiments.

In various embodiments, photonic metasurfaces are designed and/or configured to generate an electromagnetic wave, radiation, beam, and/or signal in a particular and/or designated direction due to the phases of the electric and magnetic dipoles, for example, being established at the surface of the component metamaterial structures. In various embodiments, the metamaterial structures comprise positive and/or negative structures that are shaped and/or sized such that the metamaterial array formed by the plurality of metamaterial structures is configured to provide an action signal to a respective quantum object position of the quantum object confinement apparatus responsive to an incoming signal being incident on at least a portion of the metamaterial array and/or to provide a collection signal to collection optics of the quantum computer responsive to an emitted signal being incident on at least a portion of the metamaterial array.

Conventional metasurfaces formed of dielectric materials and located near the confined quantum objects may impose significant risk of static charge buildup on the metasurfaces. The use of a transparent conducting material (e.g., ITO), in various embodiments, to form at least a shell of the metamaterial structures mitigates the risk of electrostatic buildup near the positions defined by the confinement apparatus (e.g., near the quantum objects) while maintaining a high optical efficiency. For example, various embodiments provide confinement apparatuses and/or systems comprising confinement apparatuses that are configured to reduce electrostatic buildup due to the use of dielectric materials on the surface of the confinement apparatus (e.g., to form metasurfaces thereon, etc.) In various embodiments, the electrostatic buildup on the metasurfaces is reduced with respect to conventional dielectric metasurfaces through the use of transparent conductive material to at least partially form metasurfaces on the surface of the confinement apparatus.

In one or more embodiments, at least one metasurface may be defined in a two-dimensional array of metamaterial structures. In various embodiments, the at least one metasurface may be composed of one or more metamaterial structures. The one or more metamaterial structures (e.g., pillars, columns, etc.) may be comprised of transparent conducting materials (e.g., transparent conducting oxide, and/or the like). In one or more embodiments, the one or more metamaterial structures (e.g., pillars, columns, etc.) may comprise of a solid structure of a transparent conducting material. In various embodiments, the one or more metamaterial structures (e.g., pillars, columns, etc.) may comprise of a core, wherein the core may be made of dielectric and/or non-conducting oxide material (e.g., titanium dioxide), and the core may be covered by a shell made of transparent conducting material (e.g., transparent conducting oxide, and/or the like).

FIG. 4C illustrates a portion of an example signal manipulation element, such as an action array 400 and/or collection array 440. The example signal manipulation element comprises a plurality of metamaterial structures 410. The geometry, size, arrangement, and/or polarization of the induced action signal and/or collection signal emitted by the corresponding signal manipulation element. In various embodiments, each metamaterial structure of the plurality of metamaterial structures 410 is a pillar extend out from a surface of the quantum object confinement apparatus 300 a distance in range of 0.5 nm to 1 μm. In various embodiments, the metamaterial structures are nanometer-scale structures. For example, the metamaterial structures are sub-wavelength structures. In various embodiments, a subwavelength structure is a structure that extends out from the surface and/or emitted signal that are intended to be incident on the structure and/or that is less than the wavelength of action signals and/or collection signals that intended to be emitted by the structure. In various embodiments, the metamaterial structures may be formed or made of conductive material, semi-conductor material, and/or dielectric material. In various embodiments, the metamaterial structures are negative structures.

In various embodiments, the spacing and/or height of the metamaterial structures within a metamaterial array influences and/or defines the direction at which the induced action signal or collection signal emitted by the metamaterial array propagates. For example, the spacing and/or height of the metamaterial structures with an action array 400 may be configured to cause an induced action signal to be directed toward and/or focused on the corresponding quantum object position 305. For example, the spacing and/or height of the metamaterial structures within a collection array may be configured to cause an induced collection signal to be directed toward and/or focused on the corresponding detection position 445.

### Example Metasurfaces

In various embodiments, a signal management system is configured to control the provision and/or collection of signals to and/or from respective quantum object positions defined by the quantum object confinement apparatus 300. In various embodiments, the signal management system defines optical paths used to provide signals to respective quantum object positions. The optical paths comprise respective signal manipulation elements. In various embodiments, the signal manipulation elements are configured to enable the optical paths to be transverse to the surface 350 of the quantum object confinement apparatus.

In various embodiments, the quantum object confinement apparatus 300 comprises one or more signal manipulation elements. In various embodiments, one or more of the signal manipulation elements are metamaterial arrays and each metamaterial array comprises a plurality of metamaterial structures which each define and/or comprise a respective metamaterial surface. The array of metamaterial structures (e.g., the composite surface formed by combining the respective metamaterial surfaces of the plurality of metamaterial structures) forms and/or provide a photonic metasurface. The terms metamaterial array and photonic metasurface are used interchangeably herein. A photonic metasurface is an engineered surface designed to manipulate light through coherent interface implemented through local control of the amplitude, phase, and/or polarization of reflected or transmitted light. This control is implemented by an array of optical scattering elements (e.g., the metamaterial structures), each of which have dimensions on the scale of the wavelength of light or smaller in at least one dimension, with spacing on the scale of the wavelength of light or smaller. For example, a photonic metasurface, as used herein, refers to the composite metasurface formed by the plurality of metamaterial structures of a metamaterial array. The metamaterial structures of a metamaterial array are approximately wavelength or sub-wavelength (e.g., nanometer scale), high contrast structures (compared to other portions of the surface of the quantum object confinement apparatus 300) whose geometry, size, arrangement, and orientation control the phase, amplitude, and polarization of electromagnetic waves. This control of the electromagnetic waves is not a result of the bulk material used to make the metamaterial structure, but rather a result of the size and shape of the metamaterial structures.

In an example embodiment, the signal manipulation element(s) are formed, deposited, and/or disposed on the surface of the quantum object confinement apparatus. FIG. 4A illustrates a partial cross-sectional view of a quantum object confinement apparatus wherein action arrays 400 are used to apply manipulation signals to a quantum object position 305. For example, the controller 30 controls one or more manipulation sources 60 to generate manipulation signals. The manipulation signals are provided to the quantum object confinement apparatus 300 as incoming signals 62 propagating transverse to a plane defined by a surface 350 of the quantum object confinement apparatus 300 such that the incoming signals 62 are incident on action array 400. The incoming signals 62 being incident on the action arrays 400 cause respective induced action signals 64 to be emitted towards the corresponding quantum object position 305. For example, the induced action signal 64 is incident on a quantum object 5 located at the quantum object position 305. As used herein, an action array 400 is a signal manipulation element configured to, responsive to an incoming signal generated by a manipulation source being incident on the action array 400, provide an induced action signal to the respective quantum object position. In the illustrated embodiment, the action arrays 400 are formed on portions of the surface 350 of the quantum object confinement apparatus 300 corresponding to the electrodes 310 and/or islands 330.

FIG. 4B illustrates a partial cross-sectional view of a quantum object confinement apparatus wherein a collection array 440 is used to collect an emitted signal generated by a quantum object 5 at a respective quantum object position. For example, during a qubit reading function, for example, a quantum object 5 located at the quantum object position 305 may be caused to emit an emitted signal 72. At least a portion of the emitted signal 72 is incident on the collection array 440. The at least a portion of the emitted signal 72 being incident on the collection array 440 causes an induced collection signal 74 to be emitted from the collection array 440 and toward a detection position 445. In various embodiments, collection optics are located and/or disposed at the detection position 445. For example, in the illustrated embodiment, the collection optics comprise one or more optical elements, such as collection lens 420 configured to couple at least a portion of the collection signal 74 into a collection fiber 425.

In the illustrated embodiment, the collection lens 420 is a metasurface lens formed, at least in part, of a transparent conductive oxide. For example, the collection lens 420 is a transparent electrode, in an example embodiment. The collection lens 420 is formed on and/or in a neighboring substrate 460.

In various embodiments, the neighboring substrate 460 is mounted and/or secured in relation to the confinement apparatus 300. In an example embodiment, one or more electrodes (e.g., such as the collection lens 420) are formed and/or disposed on the neighboring substrate 460. For example, electrical signals maybe provided to the one or more electrodes (e.g., such as the collection lens 420) formed and/or disposed on the neighboring substrate 460 to generate one or more electrical fields that apply a force to one or more quantum objects confined by the confinement apparatus 300. For example, the one or more electrodes (e.g., such as the collection lens 420) formed on the neighboring substrate 460 may be configured to define and/or control, at least in part, the confinement volume of the confinement apparatus 300. For example, the one or more electrodes (e.g., such as the collection lens 420) formed on the neighboring substrate 460 may be configured to define and/or control, at least in part, the confinement volume by affecting the electrical environment (e.g., electric potential and/or electric field) experienced by one or more quantum objects confined within the confinement volume.

FIG. 4C illustrates a portion of an example signal manipulation element, such as an action array 400 and/or a collection array 440. The example signal manipulation element comprises a plurality of metamaterial structures 410. The geometry, size, arrangement and/or orientation of the plurality of metamaterial structures 410 control the phase, amplitude and polarization of the induced action signal and/or collection signal emitted by the corresponding signal manipulation element. In various embodiments, each metamaterial structure of the plurality of metamaterial structures 410 is a pillar extend out from a surface 450 of the quantum object confinement apparatus 300 and/or neighboring substrate 460 (that is secured with respect to the confinement apparatus 300) a distance in a range of 0.5 nm to 1 μm. For example, the metamaterial structures are nanometer-scale structures. In various embodiments, the metamaterial structures are sub-wavelength structures. In various embodiments, a subwavelength structure is a structure that extends out from the surface 350 and/or has a diameter/side length that is less than the wavelength of incoming signals and/or emitted signals that are intended to be incident on the structure and/or that is less than the wavelength of action signals and/or collection signals that intended to be emitted by the structure. In various embodiments, the metamaterial structures may be formed or made of conductive material, semi-conductor material, and/or dielectric material. In various embodiments, the metamaterial structures are negative structures (e.g., holes, depressions, and/or the like).

In various embodiments, the radius and/or height (positive or negative) of the metamaterial structures and the spacing of metamaterial structures within a signal manipulation element (e.g., a metamaterial array) influences and/or defines the efficiency with which the signal manipulation element converts the energy and/or energy flux of an incoming signal into an action signal and/or an emitted signal into a collection signal.

In various embodiments, the shape of the metamaterial structures of a metamaterial array (e.g., in a cross-section in a plane substantially parallel to the surface 350 of the quantum object confinement apparatus 300) influences and/or defines the polarization of an induced action signal or collection signal emitted by the metamaterial array.

In various embodiments, the spacing and/or height of the metamaterial structures within a metamaterial array influences and/or defines the direction at which the induced action signal or collection signal emitted by the metamaterial array propagates. For example, the spacing and/or height of the metamaterial structures within an action array 400 may be configured to cause an induced action signal to be directed toward and/or focused at the corresponding quantum object position 305. For example, the spacing and/or height of the metamaterial structures within a collection array 440 may be configured to cause an induced collection signal to be directed toward and/or focused on the corresponding detection position 445.

In various embodiments, the action arrays 400 and/or collection arrays 440 of the quantum object confinement apparatus 300 are formed and/or disposed on the surface 350 of the quantum object confinement apparatus 300. In various embodiments, at least a portion of the surface 350 of the quantum object confinement apparatus 300 comprises of a plurality of metamaterial structures 410 (e.g., manipulation elements). In various embodiments, the one or more metamaterial structures 410 may comprise of an oxide and/or electrically insulating layer. In various embodiment, the one or more metamaterial structures 410 comprise of a transparent conducting material (e.g., ITO). Metamaterial structures comprising of transparent conducting materials provide the system with high optical efficiency while mitigating the buildup of static charge on and/or around the surface of the quantum object confinement apparatus 300. In various embodiment, a plurality of metamaterial structures 410 comprises 2-D arrays of the action array 400 and/or collection array 440 to reduce the build-up of static charge within the system. In one or more embodiment, the metasurface formed by a plurality of metamaterial structures comprising a transparent conducting material may be used as transparent electrodes for photoactive devices (e.g., PV cells, optical modulators, etc.), in addition to functioning as action arrays 400 and/or collection arrays 440.

In various embodiments, the plurality of metamaterial structure 410 located on the surface of the quantum object confinement apparatus 300 may comprise of a non-conducting oxide core 603B with a transparent conducting material shell 603A on the outer portion. In various embodiments, the metamaterial structures 410 may comprise of a core 603B made of dielectric material (e.g., titanium dioxide) and a shell 603A of transparent conducting material (e.g., ITO), wherein the core 603B and shell 603A still provide the system with high optical efficiency while reducing the static charge build-up on the surface of the quantum object confinement apparatus 300. In one or more embodiments, the core-shell metamaterial structures 410 may still operate as at least a portion of an electrode for the system. In one or more embodiments, may comprise of an outer shell 603A of transparent conducting material (e.g., indium tin oxide (ITO)) covering a dielectric (e.g., titanium dioxide) core.

In one or more embodiments, the plurality of metamaterial structures may be used as a dielectric photonic metasurface configured to modify propagation phase without resonance (e.g., truncated waveguides). In various embodiment, the photonic metasurfaces are dielectric metasurfaces using two or more electric resonances of any order to locally engineer the desired phase and amplitude response of the respective photonic metasurface. Various other types of metamaterial structures 410 that define various types of metamaterial surfaces are used in various embodiments.

Photonic metasurfaces can be design and/or configured to generate an electromagnetic wave, radiation, beam, and/or signal in a particular and/or designated direction due to the phases of the electric and magnetic dipoles, for example, being established at the surface of the component metamaterial structures. In various embodiments, the metamaterial structures comprise positive and/or negative structures that are shaped and/or sized such that the metamaterial array formed by the plurality of metamaterial structures is configured to provide an action signal to a respective quantum object position of the quantum object confinement apparatus responsive to an incoming signal being incident on at least a portion of the metamaterial array and/or to provide a collection signal to collection optics of the quantum computer responsive to an emitted signal being incident on at least a portion of the metamaterial array.

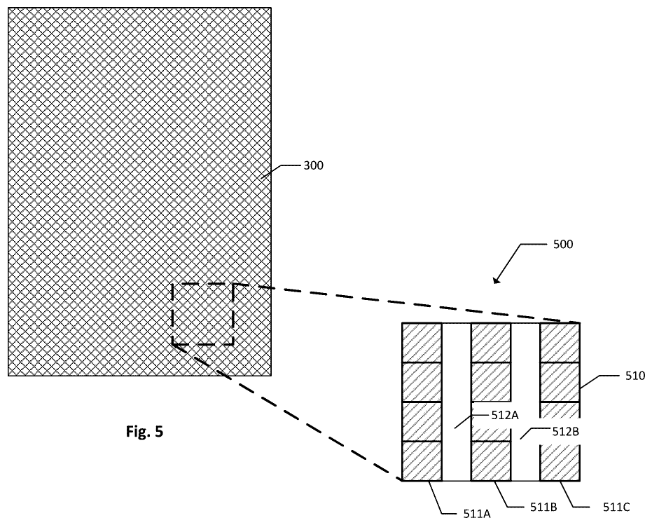

In one or more embodiments, as depicted in FIG. 5, the quantum object confinement apparatus 300 may comprise of a plurality of electrodes 500, wherein the electrodes may further comprise of a plurality of metasurfaces (e.g., 511A, 511B, 511C). In various embodiments, with further reference to FIG. 5, the one or more plurality of metasurfaces (e.g., 511A, 511B, 511C (may be bound by and RF rail 510 and/or separated by a gap (e.g., 512A and 512B).

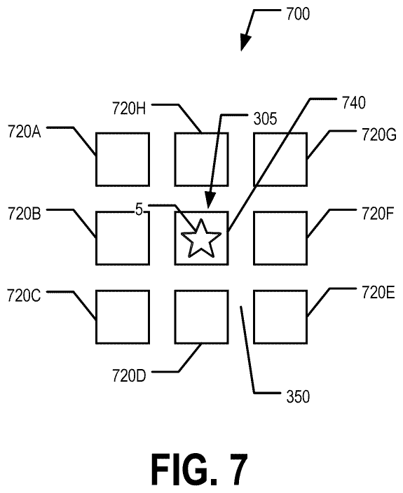

FIG. 7 another example arrangement 700 of signal manipulation elements on the surface 350 of the quantum object confinement apparatus 300. The arrangement 700 comprises a plurality of action arrays 720 (e.g., 720 A-H) and a collection array 740. In an example embodiment, each of the action arrays 720 is configured for use for performing one or more function of the quantum computer. For example, each action array 720 may be configured for use with a respective particular wavelength and/or respective wavelength range corresponding to the respective function(s). For example, each action array 720 may be configured to provide an action array 720 that is focused in a particular manner. For example, an action array 720 may be configured to focus an induced action signal on the respective quantum object position and/or on one or more portions of the respective quantum object position. The particular focus characteristics of a respective action array 720 are configured based at least in part on the corresponding function(s) that the action array 720 is designed for use in performing.

In various embodiments, the quantum object confinement apparatus 300 is located within a vacuum/cryogenic chamber, one or more radiation shields, and/or the like.

In various embodiments, the two-dimensional array of metamaterial structures 410 are located on a surface of a substrate of the quantum object confinement apparatus 300. In one or more embodiments, the two-dimensional array of metamaterial structures 410 may act as a plurality of electrodes and may be disposed on the surfaced of the quantum object confinement apparatus 300. For example, the plurality of metamaterial structures 410, wherein the metamaterial structures act like electrodes, may be used as a transparent electrode for a photoactive device.

### Exemplary Controller

In various embodiment, a quantum object confinement apparatus 300 is incorporated into a system (e.g., a quantum computer 110) comprising a controller 30. In various embodiment, the controller 30 is configured to control various element of the system (e.g., quantum computer 110). For example, the controller may be configured to control the voltage source 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or configured to manipulate and/or cause a controlled evolution of quantum state of one or more quantum objects confined by the quantum object confinement apparatus 300. In various embodiments, the controller 30 may be configured to receive signals from one or more optics collection systems.

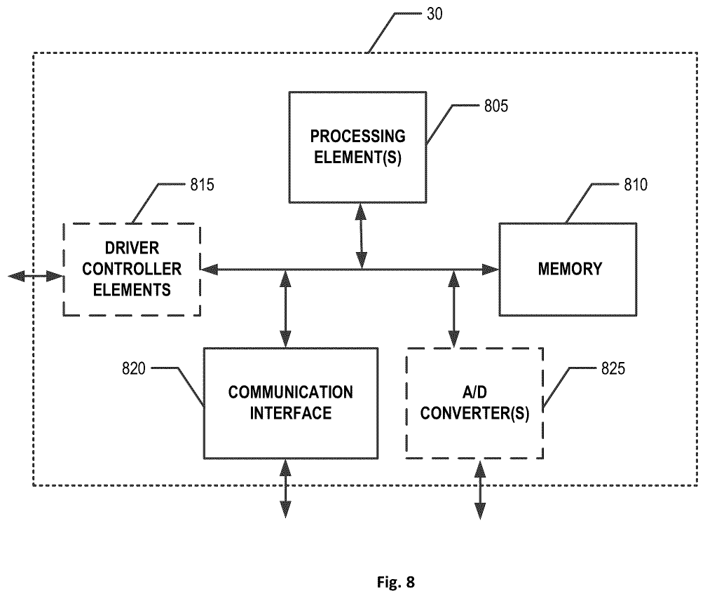

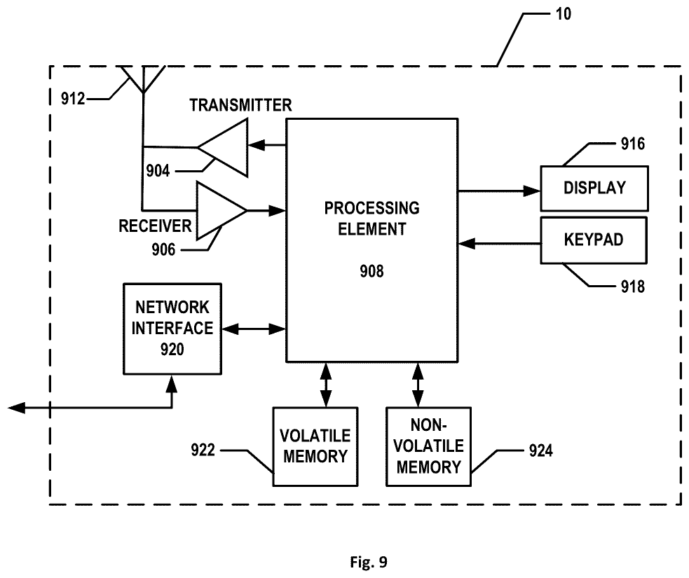

As shown in FIG. 8, in various embodiment, the controller 30 may comprise of various controller elements including processing elements 805, memory 810, driver controller element 815, a communication interface 820, analog-digital converter elements 825, and/or the like. For example, the processing elements 805 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 905 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 810 (e.g., by a processing element 805) causes the controller 30 to perform one or more steps, operations, processes, procedures, and/or the like described herein for providing manipulation signals to quantum object positions and/or collecting, detecting, capturing, and/or measuring indications of emitted signals emitted by quantum objects located at corresponding quantum object positions of the quantum object confinement apparatus 300.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 805). In various embodiments, the driver controller elements 815 may enable the controller 30 to operate a voltage source 50, manipulation sources 60, cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the quantum object confinement apparatus 300 (and/or other drivers for providing driver action sequences to potential generating elements of the quantum object confinement apparatus); cryostat and/or vacuum system component drivers; cooling system drivers, and/or the like. In various embodiments, the controller 30 comprises means for communicating and/or receiving signals from one or more optical receiver components (e.g., photodetectors of the optics collection system). For example, the controller 30 may comprise one or more analog-digital converter elements 825 configured to receive signals from one or more optical receiver components (e.g., a photodetector of the optics collection system), calibration sensors, and/or the like.

### Exemplary Computing Entity

FIG. 9 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 912, a transmitter 904 (e.g., radio), a receiver 906 (e.g., radio), and a processing element 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communication using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 920 for interfacing and/or communicating with the controller 30, for example. For example, the computing entity 10 may comprise a network interface 920 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 916 and/or speaker/speaker driver coupled to a processing element 908) and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

1. A quantum object confinement apparatus comprising,
a plurality of electrodes configured to define a confinement volume configured to confine one or more quantum objects therein, a plurality of quantum object positions defined within the confinement volume; and
one or more metasurfaces, each metasurface of the one or more metasurfaces associated with a respective quantum object position of the plurality of quantum object positions, wherein the metasurface comprises a transparent conducting oxide.

2. The quantum object confinement apparatus of claim 1, wherein the metasurface is one of the plurality of electrodes.

3. The quantum object confinement apparatus of claim 1, wherein the metasurface comprises a two-dimensional array of metamaterial structures comprising the transparent conducting oxide.

4. The quantum object confinement apparatus of claim 3, wherein the two-dimensional array of metamaterial structures is configured to enable at least one of (a) phase control or (b) wavefront shaping of an induced beam provided by the metasurface.

5. The quantum object confinement apparatus of claim 3, wherein the transparent conducting oxide is disposed at least on respective surfaces of a plurality of metamaterial structures of the two-dimensional array of metamaterial structures.

6. The quantum object confinement apparatus of claim 3, wherein the two-dimensional array of metamaterial structures is located on a surface of a substrate and the plurality of electrodes are also disposed on the surface of the substrate.

7. The quantum object confinement apparatus of claim 5, wherein each of the plurality of metamaterial structures is a pillar extending from a surface of the quantum object confinement device a distance in a range of 0.5 nm to 1 μm.

8. The quantum object confinement apparatus of claim 5, wherein the one or more metamaterial structures comprise a dielectric material.

9. The quantum object confinement apparatus of claim 8, wherein the one or more metamaterial structures comprises a core comprising the dielectric material and the core is enveloped within a shell comprising the transparent conducting oxide.

10. The quantum object confinement apparatus of claim 8, wherein the dielectric material comprises titanium dioxide.

11. The quantum object confinement apparatus of claim 9, where the one or more metamaterial structures can be used as a transparent electrode for a photoactive device.

12. The quantum object confinement apparatus of claim 10, wherein the metamaterial structures contain tunable properties related to variable free carrier concentration.

13. The quantum object confinement apparatus of claim 1, wherein the conducting transparent oxide is indium tin oxide (ITO).

14. The quantum object confinement apparatus of claim 1, wherein the one or more metasurface comprises of ITO materials used as truncated waveguides.

15. The quantum object confinement apparatus of claim 1, further comprising a controller configured to control operations of the plurality of electrodes.

16. The quantum object confinement apparatus of claim 15, wherein the controller is further configured to receive a signal indicative of the collection signal being incident at the electrodes.

17. The quantum object confinement apparatus of claim 15, wherein the system is part of a quantum computer, and the controller is configured to control the operations of the plurality of electrodes.

18. A quantum computer comprising:
a quantum object confinement apparatus comprising of:
a plurality of electrodes configured to define a confinement volume configured to confine one or more quantum objects therein, a plurality of quantum object positions defined within the confinement volume; and
one or more metasurfaces, each metasurface of the one or more metasurfaces associated with a respective quantum object position of the plurality of quantum object positions, wherein the metasurface comprises a transparent conducting oxide;
at least one manipulation source wherein the at least one manipulation source is configured to provide a manipulation signal; and
at least one optical element, wherein the at least one optical element is configured to cause the manipulation signal to be incident on the metasurface such that the metasurface causes an induced beam to be incident on the respective quantum object position.

19. The quantum computer of claim 18, further comprising at least one photodetector associated with a respective quantum object position, wherein the at least one metasurface is configured to provide an induced signal to the at least one photodetector responsive to at least a portion of an emitted signal emitted by a quantum object disposed at the respective quantum object position being incident on the metasurface.

20. The quantum computer of claim 18, wherein the metasurface is formed by a plurality of metamaterial structures, at least an outer surface of each of the plurality of metamaterial structures formed of the transparent conducting oxide.

21. The quantum object confinement apparatus of claim 1, wherein a metasurface of the one or more metasurfaces comprises an array of metamaterial structures that comprises at least one of (a) positive metamaterial structures of (b) negative metamaterial structures.

22. The quantum object confinement apparatus of claim 1, wherein a metasurface of the one or more metasurfaces comprises an array of negative metamaterial structures and the metasurface is part of a transparent electrode of the plurality of electrodes.
